(19) United States
(12) Patent Application Publication
(10) Pub. No.: US 2005/0117058 A1
(43) Pub. Date: Jun. 2, 2005

(54) Video display unit

(76) Inventor: Ikuo Nomura, Takefu-city (JP)

Correspondence Address: FLYNN THIEL BOUTELL & TANIS, P.C., 2026 RAMBLING ROAD, KALAMAZOO, MI, 49008-1699, US

(21) Appl. No.: 10/992,886

(22) Filed: Nov. 19, 2004

(30) Foreign Application Priority Data
Nov. 28, 2003 (JP) 2003-399482

(51) Int. Cl. H04N 5/68; H04N 3/27

(52) U.S. Cl. 348/554; 348/805

(57) ABSTRACT

It is an object of the invention to provide a video display unit capable of displaying an interlaced video signal or a progressive video signal on a CRT without adding a circuit such as a converter and the like which are conventionally needed. A horizontal deflecting circuit has two S-shaped capacitors and two resonance capacitors, and two voltages each having a deferent level are supplied to a FBT. When a CPU decides a scan mode of a video signal to be displayed, it implements an on or off control relative to three transistors so as to switch the voltage to be supplied to the S-shaped capacitors, the resonance capacitors and the FBT to the voltage corresponding to the decided scan mode.

### FIELD OF THE INVENTION

The invention relates to a video display unit capable of displaying a video signal of an interlaced mode (hereinafter referred to as interlaced video signal) and a video signal of a progressive mode (hereinafter referred to as progressive video signal) outputted, respectively, from a TV broadcast network or a playback system such as a DVD and the like.

### BACKGROUND OF THE INVENTION

In a conventional video display unit, an interlaced video signal processing is implemented and displayed on a CRT (Cathode Ray Tube) serving as a picture tube so as to implement video display upon reception of TV broadcast signal. A progressive mode which is adapted for displaying a freeze-frame picture or characters has been widely spread recently, and hence both the interlaced mode and the progressive modestand side by side in the present situtation. Accordingly, there is progressed a development so as to display video signals of both modes on the CRT.

For example, JP 8-9417A discloses that video data of a non-interlaced scan mode which is read out from a disk is subjected to a signal processing by a composite video signal processing circuit while synchronized with a standard composite video signal conforming to a TV system, thereby generating a composite video signal of an interlaced scan mode which corresponds to the TV system. JP 8-251545A discloses that it is decided as to whether an input video signal represents an interlaced video signal or a non-interlaced video signal, and a processing circuit for the interlaced mode or a processing circuit for the non-interlaced mode is operated in response to the result of decision. Further, JP 2002-247520A discloses a device constituted by an interlaced signal generation circuit for generating an interlaced signal from a video signal outputted from a disk playback portion, a progressive signal generation circuit for generating a progressive signal from the video signal, a control circuit for detecting as to whether the video signal represents 24 frames/second or 30 frames/second, and a switching circuit for selecting and outputting the progressive signal when the video signal represents 24 frames/second, and for selecting and outputting the interlaced signal when the video signal is 30 frames/second, respectively, based on the control by the control circuit.

If the video display unit is set to correspond to one video signal of one scan mode, the other video signal of the other scan mode has to be converted into one video signal of one scan mode by a converter or the like, as mentioned in the above mentioned references, and hence a converter and the like have to be added. Further, there occurs a problem that picture quality is degraded by the conversion of the video signal.

It is necessary to decide as to whether the video signal represents a scan mode in which the video signal can be displayed on the video display unit, and if it is decided not to be displayed, the video signal has to be converted into that conforming to the scan mode in which the video signal can be displayed on the video display unit. Accordingly, a processing circuit for converting the video signal into that conforming to the scan mode is needed and also a switching circuit has to be added.

### SUMMARY OF THE INVENTION

It is therefore an object of the invention to provide a video display unit capable of displaying video signals of two scan modes on a CRT without adding a circuit such as a converter or the like which has been conventionally needed.

To achieve the above object, the video display unit of the invention comprises a CRT for displaying video, a video signal processing circuit for converting an interlaced video signal or a progressive video signal into RGB signals and outputting the RGB signals to the CRT, a deflecting circuit for outputting a deflecting signal to the CRT upon reception of a synchronal signal from the video signal processing circuit, and a control circuit for controlling the video signal processing circuit and the deflecting circuit, wherein the deflecting circuit is comprised of first deflecting means corresponding to an interlaced mode, second deflecting means corresponding to a progressive mode, and switching means for switching between the first deflecting means and the second deflecting means, and the control circuit is comprised of deciding means for deciding as to whether either the interlaced video signal or the progressive video signal is inputted to the video signal processing circuit, and switching control means for switching the switching means based on the result of decision by the deciding means. Further, both the first and the second deflecting means are provided with S-shaped capacitors and resonance capacitors, respectively.

With the video display unit having the above mentioned configuration, since the video signal processing circuit converts the interlaced video signal or the progressive video signal into the RGB signals which can be displayed on the CRT, it is not necessary to unify the video signals of the respective scan modes into one scan mode so that the picture quality is not degraded. Further, since the first deflecting means corresponding to the interlaced mode and the second deflecting means conforming to the progressive mode can be switched therebetween in the deflecting circuit based on the result of decision by the control circuit, the video signal can be deflected to that corresponding to the scan mode so that the video signal can be displayed correctly on the CRT.

Accordingly, it is possible to display video signals of two scan modes without adding a circuit such as a converter for converting the scan modes in the video signal processing and preventing picture quality from being degraded. Since the first and the second deflecting means have a circuit configuration such as the S-shaped capacitors and the resonance capacitors conforming to the respective scan modes so that the deflecting operation can be surely implemented by the respective scan modes.

### BRIEF DESCRIPTION OF THE DRAWINGS

FIG. 1 is a block diagram of a video display unit according to the embodiment of the invention; and

FIG. 2 is a circuit configuration of a horizontal deflecting circuit.

### PREFERRED EMBODIMENT OF THE INVENTION

The video display unit of the invention according to the embodiment of the invention is now described more in detail. Since the working example described hereinafter is a preferred concrete example for working out the invention, it is variously limited technically, but the invention is not limited to the working example unless explicitly limiting the invention to the working example.

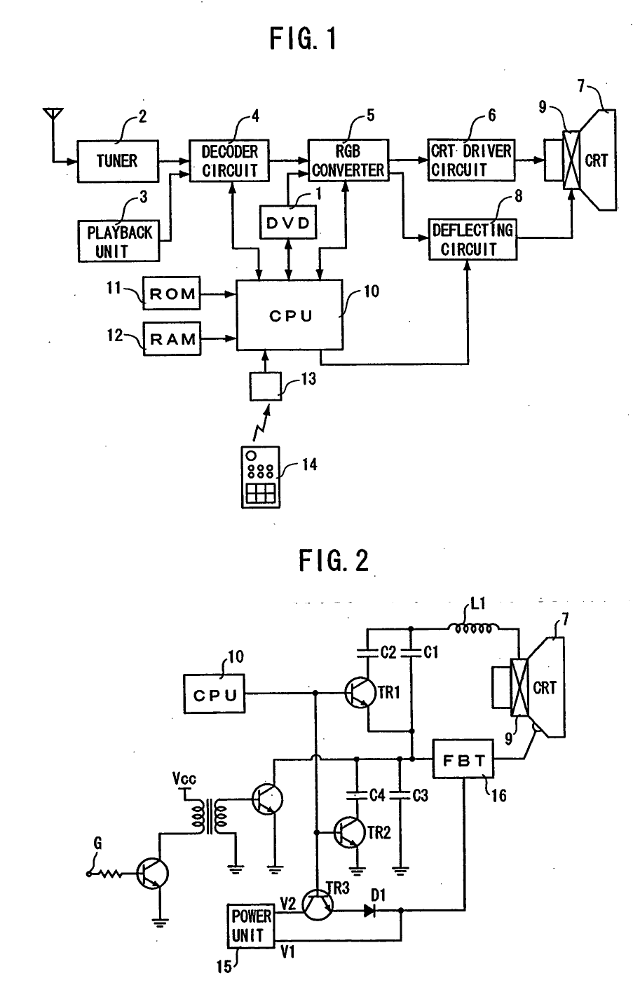

FIG. 1 is a block diagram of the video display unit according to the embodiment of the invention. In this embodiment, a DVD 1 is built in a TV receiver and an interlaced video signal is transmitted through a tuner 2 for receiving TV broadcast signal and a playback unit 3 such as a VTR and the like, and a progressive or interlaced video signal is selected by and transmitted from the DVD 1.

The video signal transmitted from the tuner 2 and the playback unit 3 is inputted to the decoder circuit 4 where brightness signal, a color-difference signal and a synchronous signal are separated from a composite signal and outputted as a component signal from the decoder circuit 4. A component signal of an interlaced mode outputted from the decoder circuit 4, or a component signal of a progressive or interlaced mode outputted from the DVD 1 is inputted to an RGB converter 5 where it is converted into RGB signals which can be displayed on a CRT 7 and outputted to a CRT diver circuit 6. The CRT diver circuit 6 outputs a driving signal to the CRT 7 and drives an electron gun in response to the RGB signals.

The RGB converter 5 transmits the synchronous signal from the component signal to a deflecting circuit 8, and the deflecting circuit 8 drives a deflecting coil 9 based on the synchronous signal to allow an electron beam discharged from the electron gun inside the CRT 7 to be deflected and scanned on a displaying surface.

A CPU 10 implements entire control of the video display unit and implements transmission and reception of the control signal between the DVD 1, the decoder circuit 4, the RGB converter 5, and the deflecting circuit 8. A ROM 11 and a RAM 12 serving as storage portions are connected to the CPU 10, respectively, wherein a program and the like necessary for control are stored in the ROM 11 and various data such as setting data necessary for control and the like are stored in the RAM 12. An operation information input portion 13 is connected to the CPU 10, and operation information inputted by a remote controller 14 is transmitted to the CPU 10 through the operation information input portion 13.

FIG. 2 is a circuit configuration of a horizontal deflecting circuit in the deflecting circuit 8. A fly back transformer (hereinafter referred to as FBT) 16 is connected to the CRT 7 for applying a high voltage, and a linearity coil L1 is connected to the deflecting coil 9. Two S-shaped capacitors C1,C2 are connected to the linearity coil L1 in parallel with each other wherein the S-shaped capacitor C2 is connected to a collector of a transistor TR1.

An emitter of the transistor TR1 and the S-shaped capacitor C1 are connected to the FBT 16 while the two resonance capacitors C3, C4 are connected in parallel with each other, and a collector of a transistor TR2 is connected to the resonance capacitor C4. An emitter of the transistor TR2 and the resonance capacitor C3 are grounded, respectively.

Two voltages V1 and V2 each having a different level are supplied from a power unit 15 to the FBT 16, wherein a line of voltage V2 is connected to the FBT 16 through a transistor TR3 and a diode Dl for preventing reverse-current. Respective bases of transistors TR1, TR2 and TR3 are connected to the CPU 10 and these transistors are simultaneously turned on or off in response to a switching signal from the CPU 10. A terminal G to which a horizontal driving pulse, which is synchronous with the synchronous signal from the RGB converter 5, is inputted, is connected between the S-shaped capacitors and the resonance capacitors through the transistors and the transformer. The horizontal driving pulse inputted to the terminal G is amplified by two transistors and the transformer, and it is inputted to the S-shaped capacitors and the resonance capacitors whereby it can be corrected in horizontal central position, respectively, and right and left expansion and contraction of a display screen owing to the capacitance of the S-shaped capacitors. A screen size in a horizontal direction and a voltage applied to the FBT 16 are corrected by the capacitance of the resonance capacitors.

Although the interlaced and progressive synchronous signals are common in a vertical frequency, namely, 60 Hz, however, they are different from each other in a horizontal frequency, namely, it is 15.75 KHz in interlaced mode while it is 31.5 KHz in the progressive mode. Accordingly, there are provided, in the horizontal deflecting circuit in FIG. 2, the S-shaped capacitors C1, C2 and the resonance capacitors C3, C4 corresponding to the horizontal frequency of the progressive mode while there are provided the S-shaped capacitor C1 and the resonance capacitor C3 in correspondence with the horizontal frequency of the interlaced mode.

When the transistors TR1, TR2 and TR3 are turned on in response to the control signal from the CPU 10, a composite capacitance of the S-shaped capacitors C1, C2 and that of resonance capacitors C3, C4 work in correspondence with the progressive mode, so that the voltage V2 is supplied to the FBT 16, thereby implementing the deflecting operation corresponding to the progressive mode. Meanwhile when the transistors TR1, TR2 and TR3 are turned off in response to the control signal from the CPU 10, the S-shaped capacitor C1 and the resonance capacitor C3 work in correspondence with the interlaced mode so that the voltage V1 is supplied to the FBT 16, thereby implementing the deflecting operation corresponding to the interlaced mode.

Accordingly, in the present embodiment, the voltage V1 to be supplied to the S-shaped capacitor C1, the resonance capacitor C3 and the FBT 16 corresponds to the first deflecting means while the voltage V2 to be supplied to the capacitors C1, C2, resonance capacitors C3, C4 and the FBT 16 corresponds to the second deflecting means. The transistors TR1, TR2 and TR3 correspond to the switching means.

Since the built-in DVD can selectively output either the interlaced video signal or the progressive video signal in the present embodiment, an operator sets either the interlaced video signal or the progressive video signal to be displayed on a screen by selecting a menu on the screen using the remote controller 14. Model setting information set by the remote controller 14 is transmitted to the CPU 10 through the operation information input portion 13, and stored in the RAM 12. In the case where the CPU 10 starts the video processing, it checks as to whether the video signal is transmitted to the decoder circuit 4 or the DVD starts a playback operation, wherein when the video signal is transmitted to the decoder circuit 4, the CPU 10 decides that the video signal represents the interlaced mode. If the DVD starts the playback operation, the CPU 10 reads out the mode setting information, and decides as to whether either mode is selected, then implements the control so as to output the video signal of the selected mode from the DVD 1. Subsequently, the CPU 10 transmits the control signal to the deflecting circuit 8 based on the decided mode, thereby turning on or off the transistors TR1, TR2 and TR3 so as to switch a voltage to be supplied to the S-shaped capacitors, the resonance capacitors and the FBT 16 to a voltage corresponding to the decided mode.

As mentioned above, since the interlaced video signal or progressive video signal is processed in the RGB converter, it is not necessary to convert the frequency of the video signal into that conforming to either mode in advance. Further, since the deflecting-circuit is switched in correspondence with a decided mode after deciding which video signal of either mode is inputted in the RGB converter, either video signal can be displayed on the screen without degradation of the video signals of both modes.

The disclosure of Japanese Patent Application No. 2003-399482 including specification, claims, and drawings, is incorporated herein by reference.

1. A video display unit comprising:
a CRT for displaying video;
a video signal processing circuit for converting an interlaced video signal or a progressive video signal into RGB signals and outputting the RGB signals to the CRT;
a deflecting circuit for outputting a deflecting signal to the CRT upon reception of a synchronal signal from the video signal processing circuit; and
a control circuit for controlling the video signal processing circuit and the deflecting circuit;
wherein the deflecting circuit is comprised of first deflecting means corresponding to an interlaced mode, second deflecting means corresponding to a progressive mode, and switching means for switching between the first deflecting means and the second deflecting means; and
wherein the control circuit is comprised of deciding means for deciding as to whether either the interlaced video signal or the progressive video signal is inputted to the video signal processing circuit, and switching control means for switching the switching means based on the result of decision by the deciding means.

2. A video display unit according to claim 1, wherein both the first and the second deflecting means are provided with S-shaped capacitors and resonance capacitors, respectively.
